(19) United States
(12) Patent Application Publication
(10) Pub. No.: US 2007/0253628 A1
(43) Pub. Date: Nov. 1, 2007

(54) METHOD OF AND APPARATUS FOR IMAGE SERVING

(75) Inventor: Stephen David Brett, Kent (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: PANDORA INTERNATIONAL LTD., Greenhithe (GB)

(21) Appl. No.: 11/738,744

(22) Filed: Apr. 23, 2007

(30) Foreign Application Priority Data
Apr. 24, 2006 (GB) 0608071.7

(51) Int. Cl. G06K 9/36; G06F 15/16

(52) U.S. Cl. 382/232; 709/203

(57) ABSTRACT

A method of transmitting images from a server to a client along a communications link, comprises the steps of: dividing a relatively high resolution image into a plurality of lower resolution tiles; transmitting a first image tile to a client terminal for editing; predicting at least one further image tile to be required; and transmitting the at least one predicted tile to the client terminal using unused capacity on the communications link.

### FIELD OF THE INVENTION

The present invention relates to a method and apparatus for image file transfer from a server to a client.

### BACKGROUND TO THE INVENTION

Client-server architectures for computing purposes have been known for at least thirty years. Such architectures commonly feature a large computer, known as a ‘server’ with significant amounts of storage ‘feeding’ many terminals or ‘clients’ with data. One common usage may be in a financial institution or bank, where all the customer records are contained within the server and when an employee of the bank wishes to inspect a customer's records, the employees' computer (a ‘terminal’ or ‘client’) requests over a data link of some form that a given customers' records are recalled by the server computer, and passed back over the link to the client computer, where the employee can view such data. The importance of such architectures are that only one set of customer data is needed—it is not necessary for every employee's terminal to have every customers' records stored locally on it. This is illustrated in FIG. 1. This architecture has many advantages, not only in cutting storage costs, but also in maintenance of only one set of ‘master’ records (although time stamped backups will obviously exist). If a transaction takes place at the client computer, then this is communicated back to the server, and the master records are updated accordingly. Other areas that commonly use such architectures are airline reservation systems, and client support centres (or ‘call centres’).

Such systems are also known for serving images from as far back as 1982, when Crosfield Electronics Ltd, of London, UK, launched the Studio 840 series page composition system. This consisted of two PDP-11 computers, connected together with an Inter computer link. This architecture featured a ‘Server’ with four large removable disc packs of images, and a ‘Client’ containing a small amount of storage for ‘view resolution’ images.

Images have substantially different properties than typical data in Client Server architectures, by virtue of being of many megabytes per frame, which is made worse by the use of multiple framed motion imagery rather than still imagery. A ten second colour sequence at 4K×4K resolution, 16 bits per colour, for three colours can easily require 18 Gigabytes of storage. The typical data for the Digital Intermediate production of a typical length movie can vary between 10 to 200 Terabytes. In comparison, typical bank transaction records, or airline booking data is in the order of Kilobytes per record; a difference of more than a million to one. Yet because the use of Client Server architectures are primarily for non-image markets, the systems developed are by no means optimal for image markets, where the data occurs in such large ‘records’.

In addition, it is often required to work on several resolutions at once, and in particular it is often necessary for an operator to view an image at a larger resolution that the image display system resolution. Consider the case where an operator has as his terminal viewing device a High Definition based viewing system. This is likely to have a resolution of 1920 picture elements by 1080 lines. However, the material that the operator may wish to work on consists of material for digital cinema mastering purposes, of resolution 4096 pixels by 3172 lines. Clearly, for the operator to view the whole image he is going to have to use a ‘scaled’ version of the image. However, at certain times it is highly desirable to utilise ‘real’ picture elements, particularly if it is desirable to trace the edge of a feature to remove it. This is because if the edge is traced on the ‘scaled’ image, when it is necessary to perform this operation on the full resolution image, we can only estimate where the line should be by extrapolating from the scaled image resolution to the full image resolution. One such example here is where it is required to remove a pistol from an actor's hand. This will almost certainly look wrong if the cut outline is specified at the scaled resolution and not the full resolution. The visibility of small amounts of the pistol in the actor's hands would look totally wrong.

In order to overcome this difficulty, it is known to separate an image into a series of tiles, each of the tiles therefore having a lower resolution than the original image. The operator can select a tile to download, the tile having within it the point of interest, such as the pistol in the actors hand in the example discussed above.

However, in order to modify the image when the point of interest extends between two tiles, and in order to modify a whole sequence of frames of an image, it is necessary for each tile to be downloaded separately. For example, the actors hand may be shown in two adjacent tiles, and therefore to complete the editing the operator will need to download first one tile, and then the other, or to download and store both tiles. In a time sequence of frames, the object of interest may move from tile to tile, and therefore the system will need to download a sequence of tiles moving on the image in different frames. This can lead to delays in the image editing process, as the operator will have to wait for each tile to be downloaded once work has finished on the preceding tile, or a tile may be required at a time when the server or the server-client link has no spare capacity.

In the present application, an image is taken to include a single still image, which is then split into a series of tiles, as well as a moving image, which consists of a series of frames, each of which is split into a corresponding array of tiles.

### SUMMARY OF THE INVENTION

Viewed from a first aspect, the present invention provides a method of transmitting images from a server to a client along a communications link, comprising the steps of:

dividing a relatively high resolution image into a plurality of lower resolution tiles;

transmitting a first image tile to a client terminal for editing;

predicting at least one further image tile to be required; and

transmitting the at least one predicted tile to the client terminal using unused capacity on the communications link.

Viewed from a second aspect, the present invention provides a computer program product containing instructions, which when executed in a system comprising a client terminal and a server connected by a communications link, will configure the server to:

divide a relatively high resolution image stored on the server into a plurality of lower resolution tiles;

transmit a first image tile to the client terminal for editing;

predict at least one further image tile to be required; and

transmit the at least one predicted tile to the client terminal using unused capacity on the communications link.

Viewed from a third aspect, the present invention provides a data processing apparatus for serving images over a communications link between a client terminal and a server, wherein the data processing apparatus comprises:

storage means at the server for storing a relatively high resolution image;

means for dividing the image stored on the server into a plurality of lower resolution tiles;

data transmission means for transmitting a first image tile to the client terminal; and

image editing means at the client terminal for editing image tiles received;

wherein the data processing apparatus is arranged to predict at least one further image tile to be required for editing; identify unused capacity on the communications link and transmit the at least one predicted tile to the client terminal using the unused capacity.

By predicting the next tile that may be required and transmitting the image data using otherwise unused capacity, the performance of the image serving is increased, as the operator will not need to separately recall the predicted tile, but instead it is available to be used without any losses or excess loading compared to the situation where the unused capacity on the link remains unused.

The predicted tile may be a tile in a different position on the same image, for example an adjacent tile, or when a motion image is being edited it may be a tile on a different frame, for example a tile in the same position on the following frame.

By predicting the required image tiles in this way, the operator can work on tiles at varying positions in the image, and across a sequence of frames, whilst minimising the loading on the communications link, and also minimising the time spent waiting by the operator for the next tile required.

More than one tile in an image or a sequence of frames may be sent. When more than one tile is predicted, then the predicted tiles are allocated unused capacity in the communications link based on the order in which they are predicted to be required. Preferably, a sequence of tiles are predicted and allocated a priority, and the tiles are transmitted to the client using unused capacity in the communications link in order of priority.

By queuing up a series of potentially required tiles the unused capacity or bandwidth of the communications link can be most effectively utilised. For example, when there is sufficient capacity to send an appropriate adjacent tile, and a corresponding tile in a following frame, as well as an adjacent tile in the following frame, then there is a greater range of options which the operator can take which will result in no new tiles being required to be transmitted. In the best case, the communications link is utilised at maximum capacity at all times, thus ensuring that no waste occurs.

In a preferred embodiment, prediction of the required tile is achieved based upon the movement of a point of interest within the image. This may occur through the operator indicating the point of interest, which is then tracked, using standard motion vector tracking techniques, to determine the next tile required.

This ensures that only tiles relevant to this point of interest are predicted.

In a further preferred embodiment, prediction of the required image tile is achieved by tracking the trajectory of previous tiles to thereby determine following tiles. For example, when the operator is tracking a line, such as the edge of an object, it may be predicted that the next tile in the direction of the preceding two or more tiles is the required tile. Alternatively, the edge that the operator is working on can be identified, and the next tile along this edge may be predicted as the required tile. In this case, standard edge extraction techniques can be used.

This allows tiles to be automatically sent to the client terminal in accordance with the way the operator is editing the image. By manually or automatically identifying a point of interest the system can decide more effectively which tiles are required, both in the same frame and in following frames.

In a preferred embodiment predictions of required tiles in following frames is achieved by deducing the tiles required in subsequent frames after correction for motion of the camera or object of interest.

Preferably, the communications link comprises an number of channels, and the predicted tiles are transmitted to the client by using channels having the smallest spare capacity, whilst that spare capacity is sufficient to carry the data required.

This ensures that the remaining spare capacity can be most effectively utilised, as it will be as large as possible in each channel, and the need to split up data is avoided.

In a preferred embodiment, the server is linked to more than one client terminal. Preferably a ring architecture is used. In this case, the unused capacity of the communications link may be distributed between predicted tiles required by the various client terminals by comparing the priority of the required tiles.

### BRIEF DESCRIPTION OF THE DRAWINGS

Preferred embodiments of the present invention will now be described by way of example only and with reference to the accompanying drawings in which:

FIG. 1 is a typical client-server architecture,

FIG. 2 shows an image broken down into lower resolution tiles,

FIG. 3 shows a tile prediction step when the operator is tracking the edge of an object,

FIG. 4 is a sequence of steps for predicting the tiles required around an object,

FIG. 5 is an example of tracking the tiles for a moving object,

FIG. 6 is a preferred client-server ‘ring’ architecture, and

FIG. 7 shows the redundancy in the case of failure of the architecture of FIG. 6.

### DETAILED DESCRIPTION OF PREFERRED EMBODIMENTS

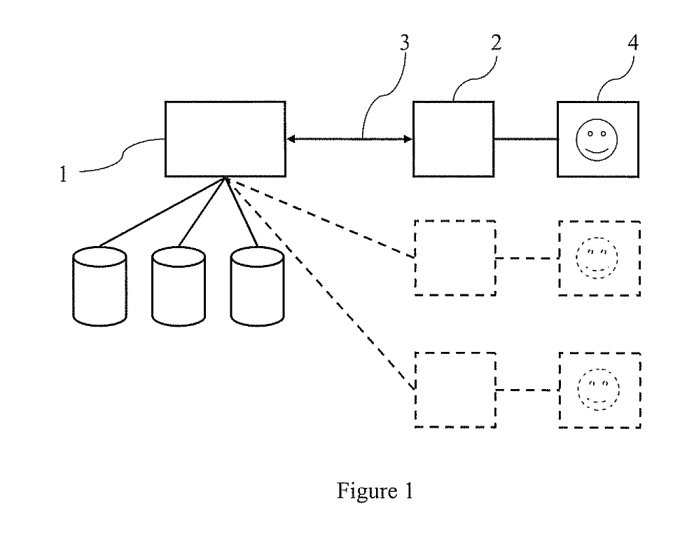

FIG. 1 shows a typical client-server architecture. A server 1 is connected to a client 2 by a link 3. The client 2 has a display screen 4 upon which the image is shown. Further clients could be connected to the server 1 as indicated by the dashed lines. In image serving, the requirement in terms of data transfer per second is generally much higher than with commercial clerical systems. A typical architecture has multiple channels or ‘pipes’ between points as the client-server links 3. Each of these ‘pipes’ has a maximum data transfer capacity.

One architecture we have found suitable to build such systems is manufactured by Picolight Incorporated of 1480 Arthur Ave Louisville, CO 80027 USA (www.picolight.com). The model used transmits data at a rate of 3.125 Gbits per second on each channel or pipe and we have used twelve of these pipes together, giving a total data capacity of 37.5 Gbits per second. It is necessary to utilise substantial buffering at each transceiver, and we have found that typically 1 Gigabyte per transceiver link is suitable.

A key feature of the invention is to utilise intelligent algorithms to make maximum usage of the links 3 to achieve the highest efficiency in operation. It is important to realise that the range of image sizes we may wish to use is variable, as mentioned earlier, there are a range of image resolutions including Standard Definition, High Definition, and other resolutions for Digital Cinema, whilst there is also a range of device specific resolutions that it may be required to work with. These include portable display devices such as the SONY PSP range.

In particular it is often necessary on an image having a resolution that is higher that the resolution of the image display system 4. As discussed above, the operator might wish to work on an image of resolution 4096 pixels by 3172 lines, using a viewing system having a resolution of 1920 picture elements by 1080 lines. The viewing system cannot display the image at full resolution, and thus it has been found necessary to break up the full resolution frame into ‘tiles’ of viewable size. The operator can then choose a tile to download and work on, without needing to access the whole image, or needing a scaled version of the original image.

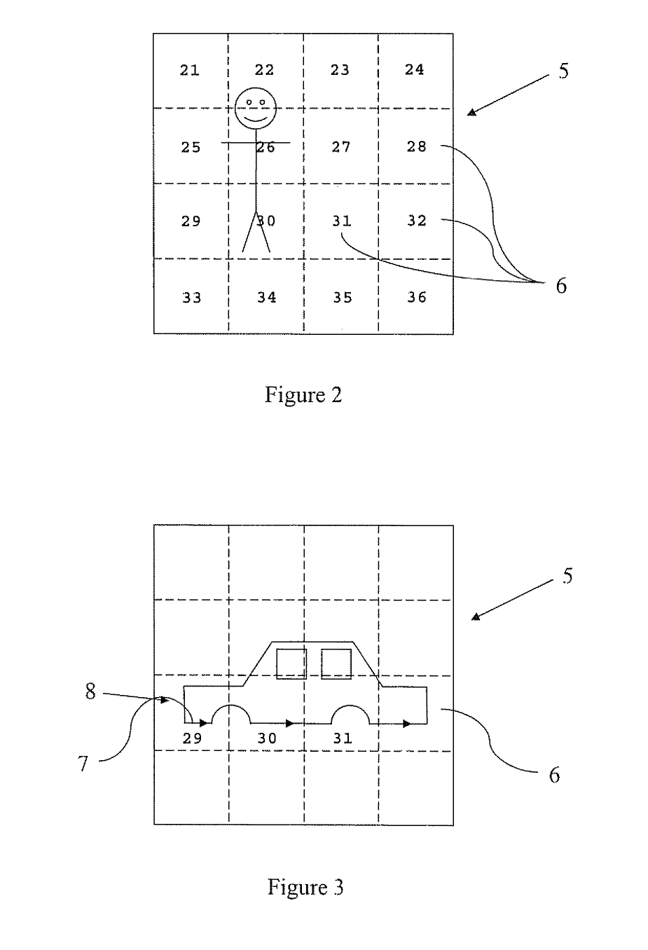

This ‘tiling’ mode is shown in FIG. 2, in which a large image 5 is broken down into sixteen tiles 6. Thus, for example, should the operator wish to work on the legs of the figure shown, then tile number 30 would be downloaded to the client from the server in accordance with a request from the operator.

Sometimes the pipelines between the server and terminal may not be fully occupied. In these cases, it is better to send data to the terminal that may be of use, rather than keep the pipelines unoccupied. Even if data is not ever used, no losses occur compared with the situation of having pipes un-used. By using otherwise redundant bandwidth in the client-server link 3 to send potentially useful data, the performance of the system is increased as some of this data will be required by the client 2, and the operator therefore does not have to wait to recall this data.

A predictive system is used to determine which elements or tiles may be of future use at the client terminal 2. Due to the nature of motion imagery, if the operator is working on a given frame of imagery, it is highly likely that he will want to work on the next frame of imagery. Therefore as a first predictive element, we will feed the next frame from the server 1 to the terminal 2 if or when pipeline bandwidth becomes available, and in particular the tiles of the next frame corresponding to the tiles of the present frame which the operator is working on.

There is then the choice of which pipe of the client-server link 3 to send the predictive data through. It has been found it most productive to send it through the pipe or pipes which are the fullest, and just have the capacity left to send the data. This leaves free whole pipes, along with pipes having a larger spare capacity, which are much more suitable for rapid deployment, as the need to split signals amongst other pipes in a rapid response scenario is avoided. Also, predictive data, by its very nature, is not likely to be immediately used; if it were, then it would have already been requested by the system. As a result, the predictive data does not need to be sent at the maximum possible speed.

A second level of predictiveness may be manually or automatically invoked. In the manual method, the operator will indicate the ‘point of interest’ in the image. This may be the lead actor, his hand that contains the pistol discussed above, or a car travelling across the scene. In this manual mode, the point of interest can be tracked, using standard motion vector tracking techniques. In these cases, we will use spare capacity in pipes to send full resolution tiles 6 of image 5 to the terminal 2, so that if it is required to edit these tiles 6, they are already available at the terminal 2, and thus the operator doesn't have to wait to recall these tiles, which may be at a time where the server 1 is over worked, and could not respond immediately.

A further level of predictiveness can be achieved by determining the next tile required in a frame as shown in FIG. 3. In this figure we see that the operator is tracing a line 7 around a large outline of an object 8, in this case a car, in the tiled image 5. The system notes the trajectory of tiles that the operator has historically worked upon, to predict further tiles. The simplest guess is that the next tile is the tile in the direction formed by the previous two (or more) tiles. Thus, based on a line 7 passing though tiles numbers 29 and 30, the system predicts that tile number 31 will then be required, and this tile is sent along spare capacity in the client-server link 3.

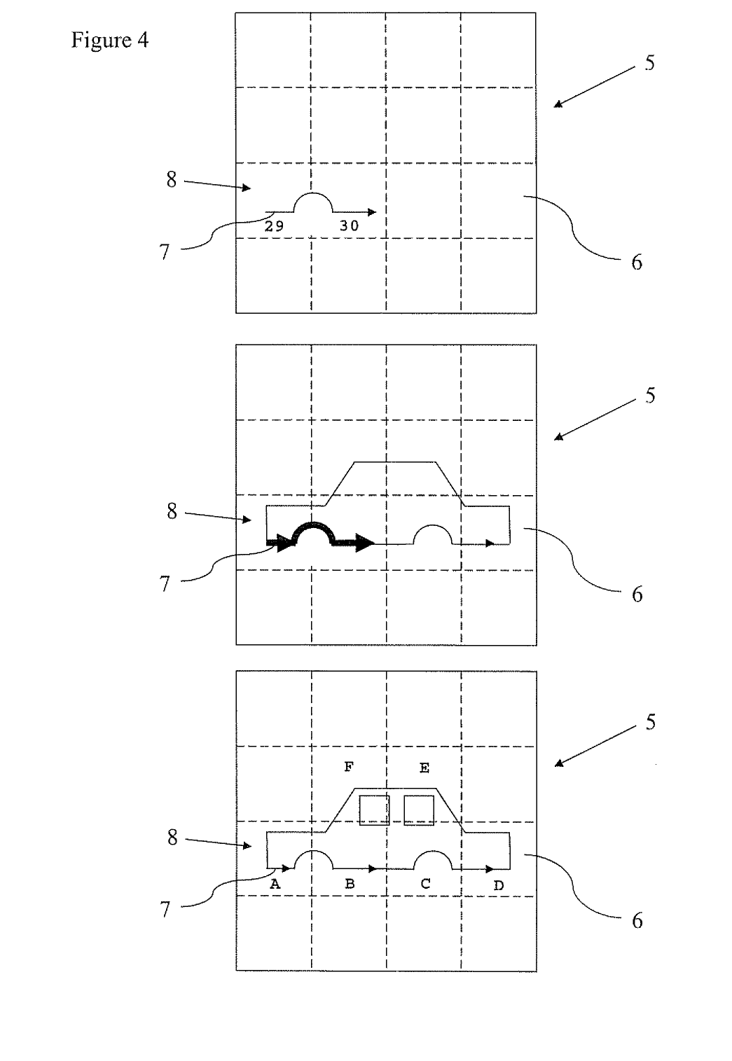

Another method of prediction is to determine the edge which the operator is working on. This can be carried out using standard edge extraction techniques and comparing the edge that the operator is working on at full resolution with the edge extracted on the terminal resolution, to predict which tiles may be of interest. This is illustrated in FIG. 4. The operator traces a line 7 around an object 8, which passes through tile numbers 29 and 30. The system uses this initial traced line 7 to identify the edge of the object 8, and then identifies a sequence of tiles, here labelled A to F, which the operator will need during the editing process. These tiles are then sent along unused bandwidth in the pipes in order that they are readily available when required.

It must be remembered that these images that are being worked on are almost certainly frames in a motion sequence, and that the predictive (in the sense of ‘next frame’) techniques still apply. Thus, as well as the appropriate ‘next tile’, the system also predicts the next frame that will be required, and sends appropriate data along unused pipeline bandwidth.

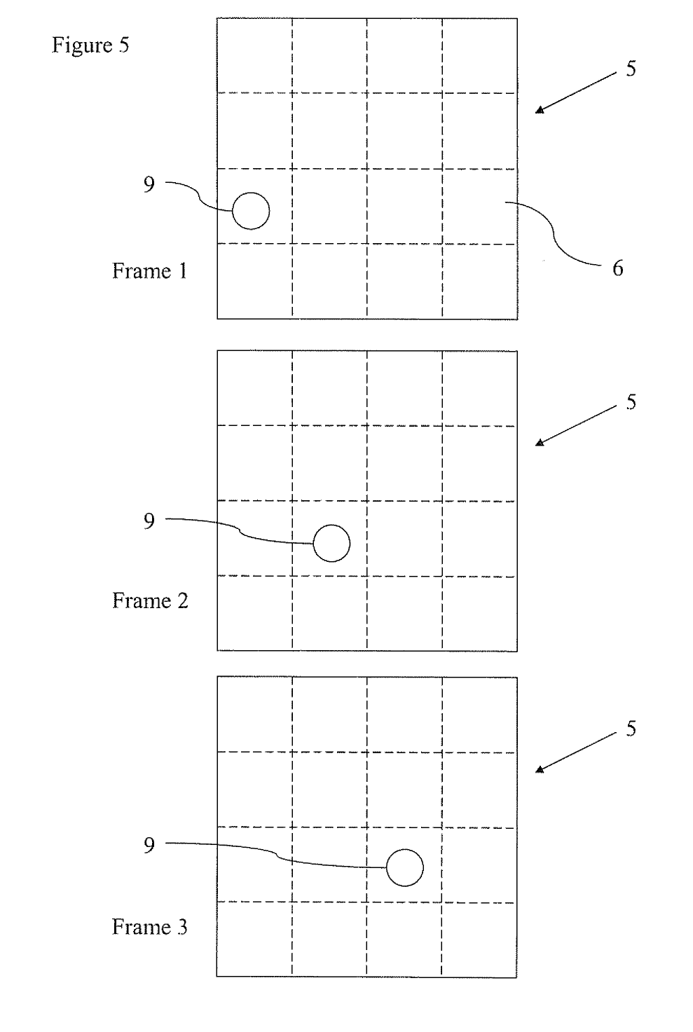

In addition, between successive frames there may be camera or object motion. One can further allow for this by deducing the tiles needed after correction for camera or object motion. A basic example of this is shown in FIG. 5, in which a ball 9 passes through different tiles in the image 5 in a sequence of three frames. Typically we will determine the motion vector displacement of the whole image, and then determine the tile position to be operated on by summing the motion vector information with the image content.

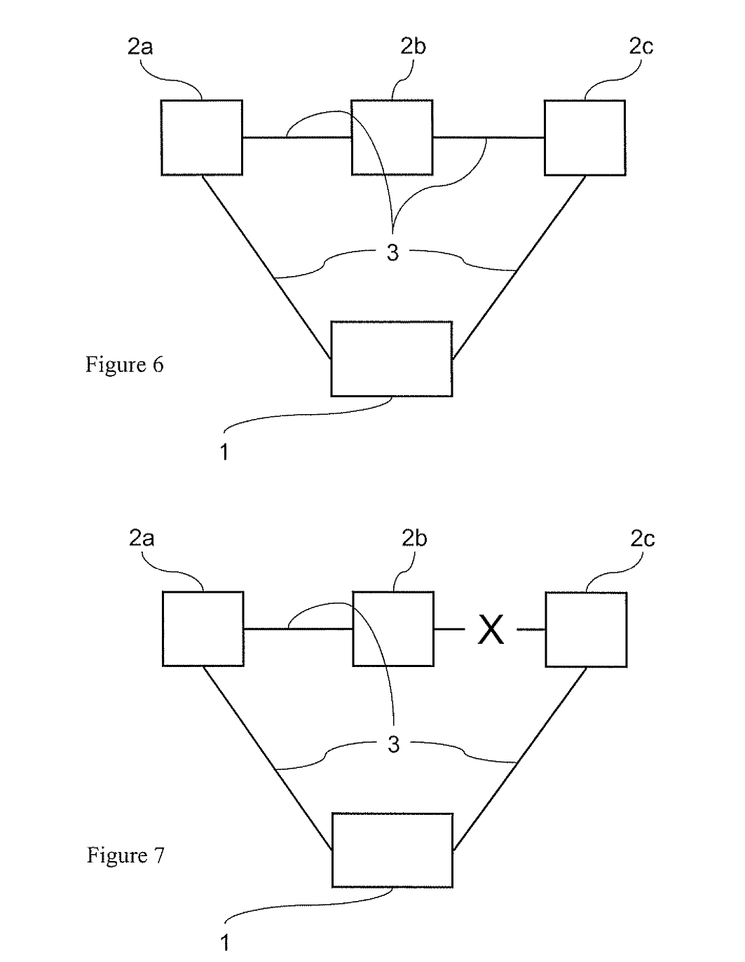

Further extensions from the above ideas are that it is highly desirable for more than one terminal 2 to be able to be fed from an Image server 1. It has been found preferable to use a ‘ring’ style architecture to connect together multiple terminals 2. This is illustrated in FIG. 6 with three client terminals 2a, 2b, 2c. Note that this ring architecture contains redundancy in operation. Each link 3 consists of twelve channels of optical link, and the server 1 and clients 2a, 2b, 2c are connected into a ring. The multiple channels provide one level of redundancy, and further, even if the whole connection between one node and another is broken, as shown in FIG. 7, the nature of the ring architecture means that there is always a route between nodes.

What is claimed is:

1. A method of transmitting images from a server to a client along a communications link, comprising:
dividing a relatively high resolution image into a plurality of lower resolution tiles;
transmitting a first image tile to a client terminal for editing;
predicting at least one further image tile to be required; and
transmitting the at least one predicted tile to the client terminal using unused capacity on the communications link.

2. A method as claimed in claim 1, wherein at least one predicted tile is an adjacent tile on the image

3. A method as claimed in claim 1, wherein a motion image containing a series of frames is being edited and at least one predicted tile is a tile in the same position on the following frame.

4. A method as claimed in claim 1, wherein more than one tile is predicted and then the predicted tiles are allocated unused capacity in the communications link based on the order in which they are predicted to be required.

5. A method as claimed in claim 4, wherein a sequence of tiles are predicted and allocated a priority order, and the tiles are transmitted to the client using unused capacity in the communications link in order of priority.

6. A method as claimed in claim 1, wherein prediction of the at least one further tile is based upon the movement of a point of interest within the image.

7. A method as claimed in claim 6, wherein the prediction comprises receiving an indication of the point of interest from the operator and tracking the point of interest to determine the next tile required.

8. A method as claimed in claim 1, wherein prediction of the required image tile is achieved by tracking the trajectory of previous tiles to thereby determine following tiles.

9. A method as claimed in claim 1, wherein predictions of required tiles in following frames in a motion image is achieved by deducing the tiles required in subsequent frames after correction for motion of the camera or point of interest.

10. A method as claimed in claim 1, wherein the communications link comprises a number of channels, and the predicted tiles are transmitted to the client by using channels having the smallest spare capacity, whilst that spare capacity is sufficient to carry the data required.

11. A method as claimed in claim 1, wherein the server is linked to more than one client terminal and the method comprises distributing the unused capacity of the communications link between predicted tiles required by the various client terminals by comparing the priority of the required tiles.

12. A computer program product containing instructions, which when executed in a data processing server connectable to a client terminal by a communications link, will configure the server to:
divide a relatively high resolution image stored on the server into a plurality of lower resolution tiles;
transmit a first image tile to the client terminal for editing;
predict at least one further image tile to be required; and
transmit the at least one predicted tile to the client terminal using unused capacity on the communications link.

13. Data processing apparatus for serving images over a communications link between a server and a client terminal, wherein the data processing apparatus comprises:
storage at the server for storing a relatively high resolution image;
an image processor for dividing the image stored on the server into a plurality of lower resolution tiles;
a data transmitter for transmitting a first image tile to the client terminal; and
an image editor at the client terminal for editing image tiles received;
wherein the data processing apparatus is arranged to predict at least one further image tile to be required for editing, to identify unused capacity on the communications link, and to transmit the at least one predicted tile to the client terminal using the unused capacity.

14. A data processing apparatus as claimed in claim 13, wherein the communications link comprises a number of channels, and data processing apparatus is arranged to transmit the predicted tiles to the client by using channels having the smallest spare capacity, whilst that spare capacity is sufficient to carry the data required.

15. A data processing apparatus as claimed in claim 13, wherein the server is linked to more than one client terminal, and the data processing apparatus is arranged to distribute the unused capacity of the communications link between predicted tiles required by the various client terminals by comparing the priority of the required tiles.
